(19) United States
(12) Patent Application Publication
(10) Pub. No.: US 2011/0255396 A1
(43) Pub. Date: Oct. 20, 2011

(54) SYSTEM FOR AUTOMATICALLY RESETTING AN ELECTRICAL CONNECTION FOR NETWORK ENABLED EQUIPMENT

(76) Inventor: Nathaniel John Altland, York, PA (US)

(21) Appl. No.: 12/763,385

(22) Filed: Apr. 20, 2010

(51) Int. Cl. H04L 12/26; H01H 9/54

(52) U.S. Cl. 370/216; 307/113

(57) ABSTRACT

A system for automatically resetting an electrical connection for selected equipment for a specific period of time and a specific number of attempts using electrical inputs and outputs connected to one or more than one controllable circuit breaker and at least one microprocessor that monitors the network connection.

### FIELD

The field of this invention relates to electrical device (Error Detection/Correction and Fault Detection/Recovery with the capability to connect to a network. More particularly, the present invention is a system for automatically power cycling selected devices after a network connection failure.

### BACKGROUND

Currently the majority of network connection problems that occur can be easily repaired by simply turning the equipment off and on again after a prescribed period of time. However, there is no system currently available that can automatically provide this reset. For example, Internet service providers (ISPs) are required to have a majority of their call center technicians spend a majority of their time to walk a user through the process of resetting the network system by removing power from a device, such as, for example, a digital subscriber line (DSL) modem among others. Vast resources are wasted by requiring a technician to assist in this simple fix that corrects over an estimated eighty percent of trouble calls received by ISPs daily. Other, more complicated systems, often require the same type of power cycling to fix errors that occur in network switch, hubs, routers, etc. Therefore there is a need for an inexpensive system for automatically power cycling selected devices after a network connection failure.

### SUMMARY

The present invention meets this need by providing a system for automatically resetting an electrical connection for selected equipment. The system comprises an enclosure having an interior portion and an exterior portion; one or more than one electrical socket affixed to the interior portion of the enclosure and protruding through the exterior portion of the enclosure; one or more than one electrical power cable connected to the one or more than one electrical socket; one or more than one electrical plug affixed to the one or more electrical power cables for attaching the enclosure to a power source; one or more than one controllable breaker attached to the one or more than one electrical socket; and a microprocessor connected to the one or more than one controllable breaker and communicatively coupled to the network.

There is also provided a method for automatically resetting an electrical connection for selected equipment by polling a network connection; determining if a connection to the network is present; indicating to a user that the connection is present; controlling one or more than one controllable breaker to remove power for a predetermined period of time from one or more than one electrical socket if a connection is present; repeating the connection a predetermined number of repetitions; and signaling a user that the connection is not restored.

In one embodiment, the polling comprises acquiring an Internet protocol address version 4, acquiring an Internet protocol address version 6, or acquiring both an Internet protocol address version 4 and an Internet protocol address version 6.

In one embodiment, the indication to the user is selected from the group consisting of a light emitting diode, a liquid crystal display, a computer icon, a computer dialog box, and an audible alarm to notify the user of a connection failure.

In another embodiment, there is provided a system for automatically resetting an electrical connection for selected equipment comprising a microprocessor communicatively coupled to the network; one or more than one controllable breaker attached to the microprocessor; and one or more than one electrical connection to the one or more than one controllable breaker. The microprocessor can be wirelessly connected to the network, wired to the network, or both wired and wirelessly connected to the network.

In another embodiment, there is provided a method for automatically resetting an electrical connection for selected equipment comprising the steps of providing a system for automatically resetting an electrical connection; polling a network connection; determining if a connection to the network is present; indicating to a user that the connection is present; controlling one or more than one controllable breaker to remove power for a predetermined period of time if no connection present; repeating the polling step through controlling one or more than one controllable breaker a predetermined number of repetitions; and signaling a user that the connection is not restored. In one embodiment, the step of polling comprises acquiring an Internet protocol address version 4, acquiring an Internet protocol address version 6, or acquiring both an Internet protocol address version 4 and an Internet protocol address version 6.

In one embodiment, the indication to the user that the network is not connected is selected from the group consisting of a light emitting diode, a liquid crystal display, a computer icon, a computer dialog box, and an audible alarm to notify the user of a connection failure.

In another embodiment, there is provided a system for automatically resetting an electrical connection for selected equipment comprising one or more than one electrical input; one or more than one controllable circuit breaker connected to the one or more than one electrical input; one or more than one electrical outputs connected to the one or more than one controllable circuit breaker; at least one microprocessor operably connected to the one or more than one controllable circuit breaker; and one or more than one network connections communicatively coupled to at least one microprocessor.

In another embodiment, there is provided a method for automatically resetting an electrical connection for selected equipment comprising the steps of: a) polling a network connection; b) determining if a connection to the network is present; c) indicating to a user that the connection is present; d) controlling one or more than one controllable breaker to remove power for a predetermined period of time if no connection in step b) is present; e) repeating steps a) through d) a predetermined number of repetitions; and f) signaling to the user that the connection is not restored.

In one embodiment, the indication to the user that the network connection is present is selected from the group consisting of a light emitting diode, a liquid crystal display, a computer icon, a computer dialog box, and an audible alarm.

In one embodiment, signaling a user that the connection is not restored is selected from the group consisting of a light emitting diode, a liquid crystal display, a computer icon, a computer dialog box, and an audible alarm.

### BRIEF DESCRIPTION OF THE DRAWINGS

These and other features, aspects and advantages of the present invention will become better understood with regard to the following description, appended claims, and accompanying figure where:

FIG. 1 is a diagram of a system for automatically resetting an electrical connection for selected equipment according to one embodiment;

FIG. 2 is a diagram of a typical home network connection to the Internet;

FIG. 3 is a flowchart of a method for automatically resetting an electrical connection for selected equipment according to one embodiment; and

FIG. 4 is a close up diagram of a system for automatically resetting an electrical connection for selected equipment according to another embodiment of the present invention.

### DETAILED DESCRIPTION

The present invention provides an inexpensive system for automatically power cycling selected devices after an Internet connection failure.

Methods, systems and devices that implement the embodiments of various features of the system will now be described with reference to the drawings. The drawings and the associated descriptions are provided to illustrate embodiments of the system and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in details in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other machine readable mediums for storing information.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

In the following description, certain terminology is used to describe certain features of one or more embodiments of the invention.

The term “machine readable medium” includes, but is not limited to portable or fixed storage devices, optical storage devices, wireless channels and various other mediums capable of storing, containing or carrying instruction(s) and/or data.

The term “microprocessor” includes, but is not limited to computers, microcontrollers, and other devices that are capable of executing programmed instructions that are contained in a storage including machine readable medium.

The term “network connection” refers to detection of the underlying physical connection wired or wireless, or the existence of another endpoint or node. Typical network connections include Asymmetric Digital Subscriber Line (ADSL), Integrated Services Digital Network (ISDN), RS-232, Synchronous Optical NETworking (SONET), Modem standards/ITU V-Series Protocols used to communicate between analog modems over voice telephone lines, Ethernet, Fiber Distributed Data Interface (FDDI), IEEE 802.11 WiFi, IEEE 802.16 WiMAX, LocalTalk, Point-to-Point Protocol, Point-to-Point Tunneling Protocol, X.25, Address Resolution Protocol (ARP), Exterior Gateway Protocol, Enhanced Interior Gateway Routing Protocol, Internet Control Message Protocol, Internet Protocol version 4 (Ipv4), Internet Protocol version 6 (Ipv6), Internet Protocol Security (IPSec), Internetwork Packet Exchange (IPX), Transmission Control Protocol (TCP), User Datagram Protocol (UDP), Server Message Block (SMB), among others that will be understood by those with skill in the art.

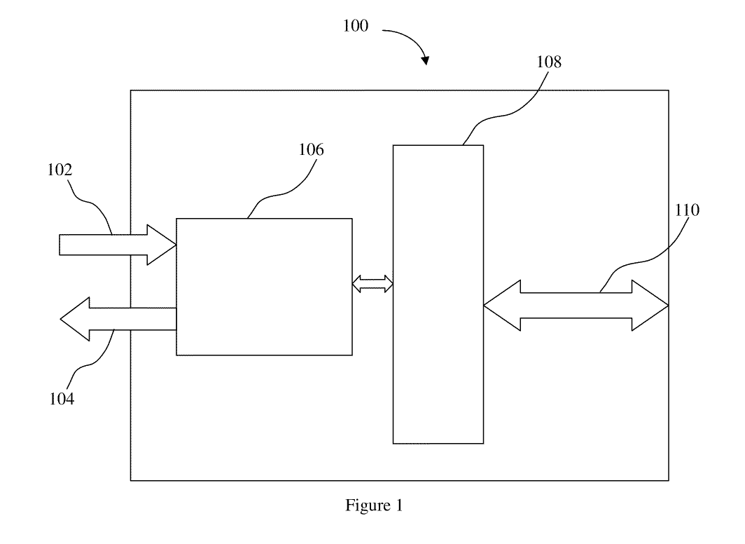

Referring now to FIG. 1, there is shown a diagram of a system 100 for automatically resetting an electrical connection for selected equipment. The system 100 can comprise one or more than one electrical input 102 and one or more than one electrical outputs 104 connected to one or more than one controllable circuit breaker 106. The one or more than one controllable circuit breaker 106 can interrupt the flow of power from the electrical input 102 causing any device connected to the electrical output 104 to lose power. The one or more than one controllable circuit breaker 106 is operably connected to at least one microprocessor 108. The microprocessor 108 can be set to cause the circuit breaker 106 to be in an “on” position, to provide electrical power for normal operation, or to be in an “off” position causing the circuit breaker 106 to cut off the flow of electrical current to the electrical output 104. The at least one microprocessor 108 is communicatively coupled to one or more than one network connections 110. The at least one microprocessor 108 can detect if the one or more than one network connection 110 is “alive”, that is whether one or more endpoints are able to communicate with each other.

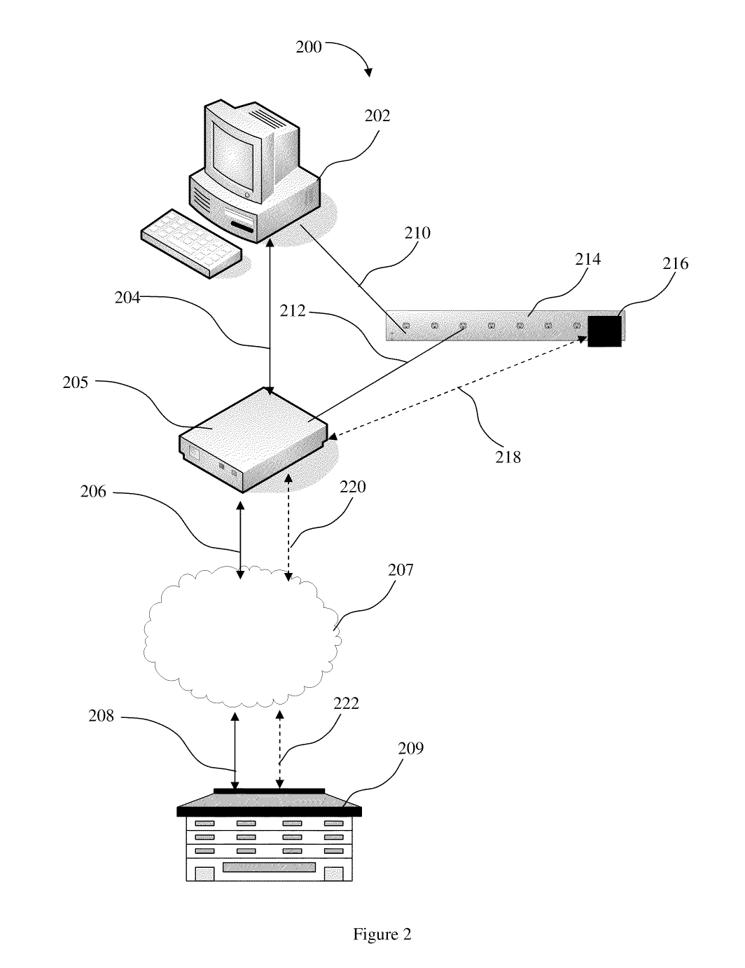

Referring now to FIG. 2 there is shown a diagram 200 of a typical home network connection to the Internet. As can be seen, this typical layout has a user's computer 202 has a power cord 210 that is plugged into a power strip 214. The user's computer 202 is connected wired or wireless to a router/modem 205 that is also plugged into the power strip 214 by a second power cord 212. The router/modem 205 has a connection 206 to the Internet 207 and from the Internet 207 there is a connection 208 to an Internet service provider (ISP) 209 where requests from the user's computer 202 are processed. In a preferred embodiment, the power strip 214 comprises the system 100 either internally or externally to control the flow of electricity to one or more than one of the power outlets. In a similar manner, the system 100 can be attached to the power strip 214, or to each of the power cords or optionally, be embedded into the power strip as indicated by block 216. The system indicated by block 216 is attached to the power source for the router/modem 205 and additionally to the ISP 209 through connections 218, 220 and 222.

The microprocessor 108 can evaluate if the router/modem 205 is communicating with the ISP. The communication can be a “ping” to another machine external to the network, loading a web page, a routing request, etc. as will be understood by those with skill in the art with reference to this disclosure. If the end-to-end network connections 218, 220 and 222 is “alive” and functioning properly the microprocessor 108 does nothing. However, if the end-to-end network connections 218, 220 and 222 fails the microprocessor's 108 evaluation, the microprocessor 108 can automatically reset the user's network by interrupting the flow of electricity to one or more selected devices, such as, for example, the router/modem 205.

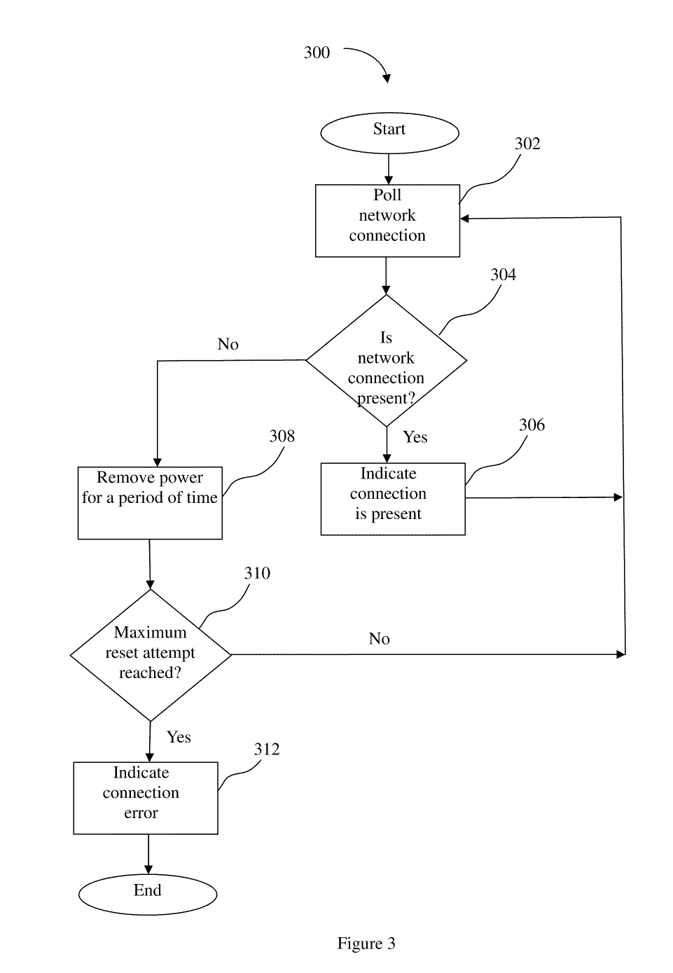

Referring now to FIG. 3, there is shown a flowchart of a method for automatically resetting an electrical connection for selected equipment. First a network connection is polled 302. Then, a determination 304 is made regarding whether a connection to the network is present. Next, if the network connection is present, an indication 306 is presented to a user that the connection is present. If, however, the network connection is not present, then the system 100 removes power 308 of a period of time to reset the device connected to the network. Next, if a maximum number of reset attempts has been reached 310 the user is signaled that the network connection has not been restored. In a preferred embodiment, the indication to the user is selected from the group consisting of a light emitting diode, a liquid crystal display, a computer icon, a computer dialog box, and an audible alarm. In a preferred embodiment, the method of signaling to the user that the connection is not restored is selected from the group consisting of a light emitting diode, a liquid crystal display, a computer icon, a computer dialog box, and an audible alarm. The power can be cycled for any period of time that it would take the attached equipment to turn off and on (power cycle). The maximum number of attempts to restore the power is set to four.

In a particularly preferred embodiment, the power is reset for 30 seconds and the maximum number of attempts to restore the power is set to four. In a preferred embodiment, the polling comprises acquiring an Internet protocol address version four (IPv4), acquiring an Internet protocol address version six (IPv6) or acquiring both an IPv4 address and an IPv6 address.

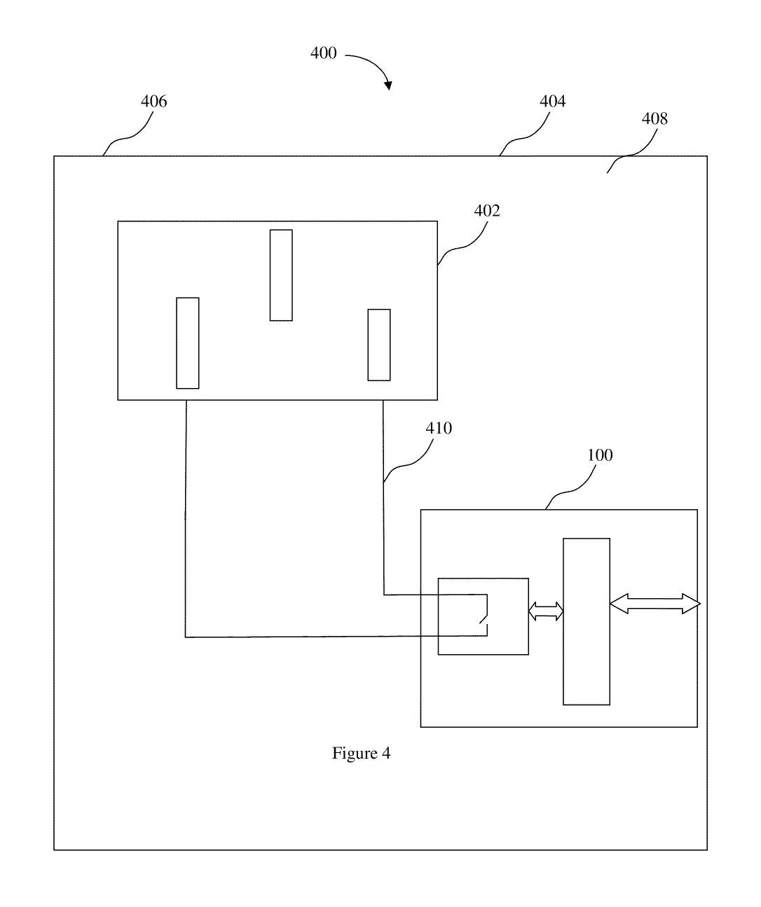

Referring now to FIG. 4, there is shown a close up diagram of a system 400 for automatically resetting an electrical connection for selected equipment. The system 400 has an enclosure 404 with an exterior portion 406 and an interior portion 408. One or more than one electrical socket 402 can be affixed to the interior portion 408 of the enclosure 404 and protrude through the exterior portion 406 of the enclosure 404. One or more than one electrical power cable 410 can be connected to one or more than one electrical socket 402 to provide interruptible power to network devices by activating the controllable circuit breaker 106.

In one embodiment, the system 100 is directly connected to an electrical socket 402. The microprocessor 108 is a microprocessor communicatively coupled to a network and to one or more than one controllable breaker 106. The microprocessor 108 controls one or more than one electrical connection to one or more than one controllable breaker and can interrupt the flow of electricity to the socket 402 if network communications are lost for a period of time. The microprocessor 108 can be wired or wirelessly connected to the network to check the connection.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference in their entirety.

What is claimed is:

1. A system for automatically resetting an electrical connection for selected equipment, the system comprising:
a) an enclosure having an interior portion and an exterior portion;
b) one or more than one electrical socket affixed to the interior portion of the enclosure and protruding through the exterior portion of the enclosure;
c) one or more than one electrical power cable connected to the one or more than one electrical socket;
d) one or more than one electrical plug affixed to the one or more electrical power cables for attaching the enclosure to a power source;
f) one or more than one controllable breakers attached to the one or more than one electrical socket; and
g) a microprocessor connected to the one or more than one controllable breakers and communicatively coupled to the network.

2. A method for automatically resetting an electrical connection for selected equipment the method comprising the steps of:
a) polling a network connection;
b) determining if a connection to the network is present;
c) indicating to a user that the connection is present;
d) controlling one or more than one controllable breakers to remove power for a predetermined period of time from one or more than one electrical socket if no connection in step b) is present;
e) repeating steps a) through d) a predetermined number of repetitions; and
f) signaling a user that the connection is not restored.

3. The method of claim 2, where the polling comprises acquiring an Internet protocol address version 4.

4. The method of claim 2, where the polling comprises acquiring an Internet protocol address version 6.

5. The method of claim 2, where the polling comprises acquiring both an Internet protocol address version 4 and an Internet protocol address version 6.

6. The method of claim 2, where the indication to the user is selected from the group consisting of a light emitting diode, a liquid crystal display, a computer icon, a computer dialog box, and an audible alarm to notify the user of a connection failure.

7. A system for automatically resetting an electrical connection for selected equipment, the system comprising:
a) a microprocessor communicatively coupled to the network;
b) one or more than one controllable breakers attached to the microprocessor; and
c) one or more than one electrical connection to the one or more than one controllable breakers.

8. The system of claim 7, where the microprocessor is wirelessly connected to the network.

9. The system of claim 7, where the microprocessor connected by a wire to the network.

10. The system of claim 7, where the microprocessor is both wired and wirelessly connected to the network.

11. A method for automatically resetting an electrical connection for selected equipment the method comprising the steps of:
a) providing the system of claim 7;
b) polling a network connection;
c) determining if a connection to the network is present;
d) indicating to a user that the connection is present;
e) controlling one or more than one controllable breakers to remove power for a predetermined period of time if no connection in step b) is present;
f) repeating steps a) through d) a predetermined number of repetitions; and
g) signaling a user that the connection is not restored.

12. The method of claim 11, where the polling comprises acquiring an Internet protocol address version 4.

13. The method of claim 11, where the polling comprises acquiring an Internet protocol address version 6.

14. The method of claim 11, where the polling comprises acquiring both an Internet protocol address version 4 and an Internet protocol address version 6.

15. The method of claim 11, where the indication to the user is selected from the group consisting of a light emitting diode, a liquid crystal display, a computer icon, a computer dialog box, and an audible alarm to notify the user of a connection failure.

16. A system for automatically resetting an electrical connection for selected equipment, the system comprising:
a) one or more than one electrical input;
b) one or more than one controllable circuit breaker connected to the one or more than one electric input;
c) one or more than one electrical outputs connected to the one or more than one controllable circuit breaker;
d) at least one microprocessor operably connected to the one or more than one controllable circuit breaker; and
e) one or more than one network connections communicatively coupled to the least one microprocessor.

17. A method for automatically resetting an electrical connection for selected equipment the method comprising the steps of:
a) polling a network connection;
b) determining if a connection to the network is present;
c) indicating to a user that the connection is present;
d) controlling one or more than one controllable breakers to remove power for a predetermined period of time if no connection in step b) is present;
e) repeating steps a) through d) a predetermined number of repetitions; and
f) signaling to the user that the connection is not restored.

18. The method of claim 17, where the indication to the user is selected from the group consisting of a light emitting diode, a liquid crystal display, a computer icon, a computer dialog box, and an audible alarm.

19. The method of claim 17, where signaling a user that the connection is not restored is selected from the group consisting of a light emitting diode, a liquid crystal display, a computer icon, a computer dialog box, and an audible alarm.
